(19) United States
(12) Patent Application Publication
(10) Pub. No.: US 2013/0217433 A1
(43) Pub. Date: Aug. 22, 2013

(54) UNIFIED TELEPHONE NUMBERING SYSTEM FOR MOTOR VEHICLES

(71) Applicant: Marcus Cezar de Souza Fonseca, Vila Mariana (BR)

(72) Inventor: Marcus Cezar de Souza Fonseca, Vila Mariana (BR)

(21) Appl. No.: 13/881,425

(22) PCT Filed: Oct. 14, 2011
(86) PCT No.: PCT/BR2011/000370

§ 371 Date: Apr. 25, 2013

(30) Foreign Application Priority Data
Oct. 26, 2010 (BR) PI 1009175-0

(51) Int. Cl. H04W 8/28

(52) U.S. Cl. CPC H04W 8/28
USPC 455/551; 341/22

(57) ABSTRACT

A system enabling telecommunication with owners of motor vehicles included in the national register of motor vehicles (RENAVAM) including two parts: (I) SIM card (using the standard adopted by the national mobile telephony system operators) which identifies the user of the UNIFIED TELEPHONE NUMBERING SYSTEM FOR MOTOR VEHICLES by the public identification plate of the motor vehicle and (II) encoding and decoding keypad. The UNIFIED TELEPHONE NUMBERING SYSTEM FOR MOTOR VEHICLES enables users of the fixed switched telephone network and the personal mobile system to communicate with owners of motor vehicles (users of the UNIFIED TELEPHONE NUMBERING SYSTEM FOR MOTOR VEHICLES), by reading and dialing the public identification plate of the motor vehicle, which is made up of alphanumeric characters, letters and numerical digits, on the telephone handset.

The UNIFIED TELEPHONE NUMBERING SYSTEM FOR MOTOR VEHICLES enables the telecommunication with owners of cars listed in the national register of motor vehicles (RENAVAM).These vehicles are identified by telephone users by reading and typing the vehicle's public license plates, standard 3(three) letters and 4(four) numerals (numeric characters). The UNIFIED TELEPHONE NUMBERING SYSTEM FOR MOTOR VEHICLES comprehends two parts: (I) keypad handset encoder/decoder (named Soteroverso keypad) which is a reference table for the user, and (II) one SIM card (named SIM Vei), exclusively produced for the owners of motor vehicles identified in conformity with the RENAVAM standard, organized by grouping alphanumeric characters, 3(three) letters and 4 (four) numerals (numeric characters).

The regulatory references used to describe the state of art technology are:

1—Regulation of the Numbering to Identify Accesses, Interfaces and Network Outlines of the Personal Mobile Service

Chapter I General Rules:

Article. 4^{o} The organization of the Numbering Resources that characterizes the Numbering Plan that identify the Accesses, Interfaces and Network Outlines of the Personal Mobile Service (PMS) is regulated according to the Numbering Regulation of the Administration of Numbering Resources, as well as according to the recommendations of ITU (International Telecommunication Union).

Article. 5^{o} The structure of the Numbering Plan defined in this Regulation adopts the uniform and standardized forms, lengths, representations and meanings according to national and international PMS scope of the Numbering Resources to Identify the Accesses, Interfaces and Network Outlines.

Article 6^{o} The Numbering Resources used in the Numbering Plan to identify the Accesses, Interfaces and Network Outlines of the PMS are represented in the decimal standard, by groups of numeric characters consisting of the digits “0” to “9”.

Section II

International Identification Code of Mobile Access

Article 9^{o} The International Mobile Subscriber Identity—IMSI has standardized format, represented by the series:
N15 N14 N13+N12 N11+N10 N9+N8 N7 N6 N5 N4 N3 N2 N1

IMSI

I—the series [N15N14N13] represent the country of origin of the Mobile Access—MCC (Mobile Country Code), established by the International Telecommunication Union—ITU;
N15 N14 N13 MCC

II—he series [N12N11] represent the support of telephone network of the

PMS—MNC (Personal Mobile Service—Mobile Network Code), established in Brazil by Anatel;
N12 N11

MNC

III—The series of standard [N10N9+N8N7N6N5N4N3N2N1] represent the Identification of Mobile Access—MSIN (Mobile Subscriber Identification Number), made of the conjunctions of the series [N10N9], that represent the National Code (CN), and from the series [N8N7N6N5N4N3N2N1], that represent the User identification that corresponds to the User Access Code defined in the Numbering Regulation of the Personal Mobile Service (PMS).
N10 N9+N8 N7 N6 N5 N4 N3 N2 N1

CN User Identification

MSIN

Article 10 Each Mobile Access of the PMS must be designated by only one IMSI code, so that this code is also stored in the Mobile Station or in the User Identification Module and in the Commutation and Control Center or its equivalent.

Article 11 The Use Access Code is sent whenever the calls are made through the identification of the user who makes the call.

2—Resolution 231 from Mar. 15, 2007. Establishment of the Vehicles Public License Plate Number Identification System.

Article 1^{o} After its registration in the traffic agency, each vehicle will be identified through their front and back license plate number, fixed in first plan and being part of it, containing 7 (seven) alphanumeric characters individualized with the first group consisting of 3 (three), as the result of the arrangement, repeating 26 (twenty six) letters, taken three in three, and with the second group consisting of 4 (four), as the result of the arrangement, with repetition of 10 (ten) numbers, taken four in four.

From the analysis of the regulatory documents of the telephone user identification system from the PMS and from the registration of motor vehicles in the RENAVAM it is understood that it is impossible to establish contacts via telecommunication network through the use of public license plates. The users of the telephone system (PSTN/PMS) can only be identified through grouping of numbers (numeric characters) whereas the owners of motor vehicles are identified through letters and numbers combined (alphanumeric characters).

Another problem of the state of art technology is the unavailability of numbering series for the telephone in the PMS numbering plan to attend all the country's fleet of motor vehicles, therefore, the adoption of the UNIFIED TELEPHONE NUMBERING SYSTEM FOR MOTOR VEHICLES also solves this technical limitation.

The objective of the UNIFIED TELEPHONE NUMBERING SYSTEM FOR MOTOR VEHICLES is to allow the communication of users of the telephone system (PSTN and PMS) with owners of motor vehicles, using the vehicle license plate identification from RENAVAM as reference. From the analysis of the regulatory documents we conclude that in today's state of art technology the telecommunication intended is impossible to be realized.

The UNIFIED TELEPHONE NUMBERING SYSTEM FOR MOTOR VEHICLES has the technical solutions to allow this type of telecommunication and they are described in this patent application.

The UNIFIED TELEPHONE NUMBERING SYSTEM FOR MOTOR VEHICLES matches one only telephone number of the telephone system with the public motor vehicles license plate in a simple and direct way to telephone users and it may also be done automatically, depending on the technical resources of the telephone handset used, either switched or mobile, analog or digital.

The UNIFIED TELEPHONE NUMBERING SYSTEM FOR MOTOR VEHICLES demands, at the least, ten numbers for the identification of a user in the new system, the one related unequivocally with a public motor vehicle's license plate enrolled in the RENAVAM.

It is good to remember that the RENAVAM system allows only one identification license plate per vehicle in Brazil, which remains with the motor vehicle from its purchase until its disuse, independently of its owners or states and cities where the motor vehicle has been enrolled during its lifetime. In the same way, in the UNIFIED TELEPHONE NUMBERING SYSTEM FOR MOTOR VEHICLES, the number of the vehicle telephone identification will not change, i.e., any of the vehicle owners who get hold of the register in the RENEVAM can request the telephone number associated with the license plate number of his/her vehicle to the system operator, and this right passes to the new owner, whenever the vehicle changes owner.

Therefore, the UNIFIED TELEPHONE NUMBERING SYSTEM FOR MOTOR VEHICLES does not need the region area code for the user identification, i.e., it's impossible for two cars to have the same license plate in the different states/cities (not to the PSTN/PMS telephone systems, in which this duplicity of users identification numbers for different area codes is a reality).

This RENAVAM's characteristic allows the use of only one national access user code to the UNIFIED TELEPHONE NUMBERING SYSTEM FOR MOTOR VEHICLES reserving a complete series of numbers, composed of 10 digits (numeric characters), exclusively for user identification of the UNIFIED TELEPHONE NUMBERING SYSTEM FOR MOTOR VEHICLES, avoiding, in this manner, numbering conflicts (dubious identification) among the new users of the UNIFIED TELEPHONE NUMBERING SYSTEM FOR MOTOR VEHICLES and the users of the actual systems PSTN and PMS.

The adoption of the UNIFIED TELEPHONE NUMBERING SYSTEM FOR MOTOR VEHICLES will bring benefits for various areas of our society:

For the Government's Administration: The UNIFIED TELEPHONE NUMBERING SYSTEM FOR MOTOR VEHICLES will allow to send documents (fines, collecting of taxes, etc.) via telecommunication (SMS, MMS) to owners of motor vehicles. This technical innovation will lead to a decrease of public expenses in various departments of the the Government's Administration (municipalities, states and federal);

For the motor vehicles owners: the UNIFIED TELEPHONE NUMBERING SYSTEM FOR MOTOR VEHICLES will allow the monitoring of vehicles and the access to a variety of online services that is going to be offered at the adoption of this system;

For the Brazilian citizens (users of PSTN/PMS): the UNIFIED TELEPHONE NUMBERING SYSTEM FOR MOTOR VEHICLES enables the communication of telephone users with any motor vehicle. This innovation has not been possible with the state of art technology available until now.

The Brazilian citizens will be able to follow the behavior of car drivers through a direct connection of telecommunication with companies or persons owners of motor vehicles, and they will also be able to take the benefits of the new services to be developed by those same companies or professionals using the UNIFIED TELEPHONE NUMBERING SYSTEM FOR MOTOR VEHICLES;

Environment: the UNIFIED TELEPHONE NUMBERING SYSTEM FOR MOTOR VEHICLES will substantially decrease the use of paper of the departments of federal, state and municipality governments in communicating with the owners of the vehicles.

Paper use will decrease as means of communication for motor vehicles owners, therefore decreasing the demand for natural resources, consequently diminishing environmental degradation and thus contributing to the improvement of life quality in the planet;

The main object of the UNIFIED TELEPHONE NUMBERING SYSTEM FOR MOTOR VEHICLES is a SIM card named SimVei (vehicle's SIM card) of exclusive use of the motor vehicle (for its lifetime, independently of change of its owners). It can be identified by the user of the telephone system and owners of motor vehicles by the format of the public license plate identification with 3 (three) letters and 4 (four) digits (for example: ABC-1234).

However, the international standard for telephone subscribers identification allows only the identification of users through numerals (numerical characters). Therefore one more complementary object is needful, an encoder/decoder which allows the telephone subscriber to switch letters into numerals (and vice versa) in an easy and prompt manner.

The encoder/decoder operation to be performed by the user has been based on the telephone keypad adopted worldwide which combines the numerals 1 (one), 2 (two), 3 (three), 4 (four), 5 (five), 6 (six), 7 (seven), 8 (eight), 9 (nine) and 0 (zero) and the 26 alphabetic letters (A, B, C, D, E, F, G, H, I, J, K, L, M, N, O, P, Q, R, S, T, U, V, W, X, Y, Z) adding to it a new encoder/decoder standard, the invention of this patent. The current standard and the new standard to be adopted are explained below:

1—Current Standard: keypad in state of art technology

Numeral key “1”: without related letters

Numeral key “2”: related letters A, B and C

Numeral key “3”: related letters D, E and F

Numeral key “4”: related letters G, H and I

Numeral key “5”: related letters J, K and L

Numeral key “6”: related letters M, N and O

Numeral key “7”: related letters P, Q, R and S

Numeral key “8”: related letters T, U and V

Numeral key “9”: related letters W, X, Y and Z

Numeral key “0”: without related letters

2—Standard to be adopted: new keys representation for the telephone keypad which is the object of the patent, encoder/decoder keypad from the UNIFIED TELEPHONE NUMBERING SYSTEM FOR MOTOR VEHICLES (FIG. 1)

Numeral key “1”: without letters, only symbols or figures

Numeral key “2”: related letters A(20), B(21) and C(22)

Numeral key “3”: related letters D(30), E(31) and F(32)

Numeral key “4”: related letters G(40), H(41) and 1(42)

Numeral key “5”: related letters J(50), K(51) and L(52)

Numeral key “6”: related letters M(60), N(61) and O(62)

Numeral key “7”: related letters P(70), Q(71), R(72) and S(73)

Numeral key “8”: related letters T(80), U(81) and V(82)

Numeral key “9”: related letters W(90), X(91), Y(92) and Z(93)

Numeral key “0”: without letters, only symbols

Therefore, in order to operate the UNIFIED TELEPHONE NUMBERING SYSTEM FOR MOTOR VEHICLES a new encoder/decoder keypad is necessary in order to relate each one of the letters, printed on the standard telephone keypad to two numbers (numerical characters) of the new standard.

This development will allow the telephone subscriber to relate each letter to a decimal number, so that when it is needed to communicate with a motor vehicle public license number, for example: ABC-1234; the user will type the correspondent decimal numbers on the telephone in order to initiate the telecommunication.

With the adoption of the telephone keypad encoder/decoder described above, whenever a telephone user wants to communicate with a vehicle with license plate e.g. ABC-1234, he will type on the keypad the numerals associated to the letters plus the license plate numerals. Thus, the letter “A” relates to number 20; letter “B” to number 21 and for the letter “C” the number 22, followed by the 1234 (the four numerals of the motor vehicle license plate identification). Therefore, the realized encoding through the telephone keypad would be the telephone number: 2021221234 which represents in a unique way the encoded motor vehicle license plate ABC-1234.

The decimals that are related to each letter of the alphabet can, by evaluation of the telecommunication regulatory department (Anatel), be standardized by any numeric combination, so that it may be adapted to the telephone users identification characteristics.

Generically, each letter of the alphabet printed on the technical state of art keypad can be related to a decimal (XY) with numerical variables “X” and “Y” switching from “0”(zero) to “9”, taking as a necessary and sufficient reason a decimal number for each letter of the alphabet, that is, our alphabet with 26 letters must be encoded with a combination of 26 decimals from any logic criteria for the user. It is worth noting that there is a hundred possible decimals to be chosen from to a two digits system (systems with more than two digits can be implemented with the adoption of the UNIFIED TELEPHONE NUMBERING SYSTEM FOR MOTOR VEHICLES).

The encoder decimals chosen for the keypad of the UNIFIED TELEPHONE NUMBERING SYSTEM FOR MOTOR VEHICLES as referred in this patent application are related to the standard keys for a technical state of art telephone, individualized by a single numeral of the decimal system combined with its respective letters (printed on the same key).

The new standard, object of this patent, increases one unit to the variable Y (being 0 (zero) the initial reference) for each letter printed on the key correspondent to its numeral, which becomes the reference to determine the numeric identity of the variable “X” (constant for this key), in the decimal represented by “XY”.

A second option, among the many encoding possibilities would be to fix the unit “Y” based on the numeral printed on the specific key and vary “X” adding one (1) more, so that a decimal is composed for each letter printed on the keypad that relates with the representative numeral of the selected key.

Generic encoding as below:
L(n) if and only if XY(n)

Where, L(n) is different from L(n+1), being L an alphabet variable, ranging from “A” to “Z” (26 letters of the alphabet), and “n” ranging from 1 to 26, where XY is any decimal so that XY(n) is different from XY(n+1)

The nowadays available technology in most of the telephone sets can automate this encoder/decoder process of the UNIFIED TELEPHONE NUMBERING SYSTEM FOR MOTOR VEHICLES through the two fluxes described below:

The automate process must be adopted in order to allow the communication via telephone (voice, sms or mms) from a telephone user (PSTN/PMS) to a UNIFIED TELEPHONE NUMBERING SYSTEM FOR MOTOR VEHICLES user, identified by the vehicle public license plate of Renavam standard. The devices must have appropriated technology to implement the encoder/decoder of the UNIFIED TELEPHONE NUMBERING SYSTEM FOR MOTOR VEHICLES.

1—The user chooses the selector key of the UNIFIED TELEPHONE NUMBERING SYSTEM FOR MOTOR VEHICLES or the national system code of identification.

2—The user types 3(three) letters and 4 (four) numerals

3—The user chooses the appropriate key to send a message or make a telephone call;

4—The device automatically converts each letter in a decimal (two digits) based on the encoding represented on the reference keypad of the new standard (table 1);

5—The device transmits to the telephone network according to the international telecommunication standard;

B—Receiving call or message (sms/mms) from the user of the UNIFIED TELEPHONE NUMBERING SYSTEM FOR MOTOR VEHICLES, identified by the vehicle's public license plate of Renavam standard and represented in the telephone network by ten digits (numeric characters).

The following flux must be adopted in the devices to be automated which have appropriate technology to implement the encoder/decoder of the UNIFIED TELEPHONE NUMBERING SYSTEM FOR MOTOR VEHICLES:

1—The device identifies the signals of ten numerical digits of the UNIFIED TELEPHONE NUMBERING SYSTEM FOR MOTOR VEHICLES user

2—The device decodes the 6 (six) first numerical digits (reference count position: left to right) of the identification number of the UNIFIED TELEPHONE NUMBERING SYSTEM FOR MOTOR VEHICLES user in 3 (three) letter, with parity of two digits for each letter according with the keypad encoder/decoder of the UNIFIED TELEPHONE NUMBERING SYSTEM FOR MOTOR VEHICLES (table 1).

3—The number of the vehicle license plate enrolled in the Renavam is displayed on the telephone in its decoded form, i.e., 3(three) letters and 4(four) numerical digits.

(Table 1, encoder/decoder standard adopted by the UNIFIED
TELEPHONE NUMBERING SYSTEM FOR MOTOR VEHICLES)

| A | B | C | D | E | F | G | H | I | J |
|---|---|---|---|---|---|---|---|---|---|
| 20 | 21 | 22 | 30 | 31 | 32 | 40 | 41 | 42 | 50 |
| K | L | M | N | O | P | Q | R | S | T |
| 51 | 52 | 60 | 61 | 62 | 70 | 71 | 72 | 73 | 80 |
| U | V | W | X | Y | Z | | | | |
| 81 | 82 | 90 | 91 | 92 | 93 | | | | |

1. ENCODER/DECODER KEYPAD of the UNIFIED TELEPHONE NUMBERING SYSTEM FOR MOTOR VEHICLES comprising: the printing of an encoder/decoder decimal number for each letter of the alphabet printed on the standard handset keys, following encoder/decoder table 1:

| A | B | C | D | E | F | G | H | I | J |
|---|---|---|---|---|---|---|---|---|---|
| 20 | 21 | 22 | 30 | 31 | 32 | 40 | 41 | 42 | 50 |
| K | L | M | N | O | P | Q | R | S | T |
| 51 | 52 | 60 | 61 | 62 | 70 | 71 | 72 | 73 | 80 |
| U | V | W | X | Y | Z | | | | |
| 81 | 82 | 90 | 91 | 92 | 93 | | | | |

and variations thereof which may required by regulatory agencies, wherein: L(n) if and only if XY(n); where, L(n) is different from L(n+1), where L is an alphabetic variable, ranging from “A” through “Z” (with all the 26 alphabet letters) assigned, and “n” ranging from 1 through 26, added by one unit, where XY is any decimal number so that XY(n) is other than XY(n+1), where the variable “X” and “Y” may take the following numeric characters: 1(one), 2(two), 3(three), 4(four), 5(five), 6(six), 7(seven), 8(eight), 9(nine) or 0(zero).

2. The automated encoder/decoder keypad of the UNIFIED TELEPHONE NUMBERING SYSTEM FOR MOTOR VEHICLES, comprising: a digital encoder/decoder telephone handsets according to the processes described next: For Active User, the-person who makes the telephone call, The Active User chooses the key of the UNIFIED TELEPHONE NUMBERING SYSTEM FOR MOTOR VEHICLES or of the national code system (defined by the regulatory agencies); the Active User dials 3 (three) letters and 4 (four) numerical digits; the Active User selects the appropriated key to send a message or to make a phone call; the Device automatically converts each letter into a group of decimals (two numerical digits) based on the codification represented by the keypad reference of the new standard (table); the Device broadcasts to the telephone network the number in accordance with the international telecommunication standards, For Passive User receptor-of telephone call, The device identifies the signal of ten numerical digits of the User of the UNIFIED TELEPHONE NUMBERING SYSTEM FOR MOTOR VEHICLES; The device decoders for the Passive User the 6 (six) first numerical digits (reference, position count from the left to the right) of the UNIFIED TELEPHONE NUMBERING SYSTEM FOR MOTOR VEHICLES into 3 (three) letters; For each letter the parity of two numerical digits is used in conformity with the encoder/decoder keypad of the UNIFIED TELEPHONE NUMBERING SYSTEM FOR MOTOR VEHICLES,. encoder/decoder table:

| A | B | C | D | E | F | G | H | I | J |
|---|---|---|---|---|---|---|---|---|---|
| 20 | 21 | 22 | 30 | 31 | 32 | 40 | 41 | 42 | 50 |
| K | L | M | N | O | P | Q | R | S | T |
| 51 | 52 | 60 | 61 | 62 | 70 | 71 | 72 | 73 | 80 |
| U | V | W | X | Y | Z | | | | |
| 81 | 82 | 90 | 91 | 92 | 93 | | | | |

wherein the license plate number registered at Renavam (national register of motor vehicles) is displayed on the telephone screen in decoded form, i.e., 3(three) letters and 4(four) numerals (numerical digits).

3. The SIM card, comprising: a telephone chip which contains as user identification number the UNIFIED TELEPHONE NUMBERING SYSTEM FOR MOTOR VEHICLES' public license plate encoded and decoded and having stored thereon instructions for implementing the following encoder/decoder table:

| A | B | C | D | E | F | G | H | I | J |
|---|---|---|---|---|---|---|---|---|---|
| 20 | 21 | 22 | 30 | 31 | 32 | 40 | 41 | 42 | 50 |
| K | L | M | N | O | P | Q | R | S | T |
| 51 | 52 | 60 | 61 | 62 | 70 | 71 | 72 | 73 | 80 |
| U | V | W | X | Y | Z | | | | |
| 81 | 82 | 90 | 91 | 92 | 93 | | | | |
